(19) United States
(12) Patent Application Publication
(10) Pub. No.: US 2019/0258196 A1
(43) Pub. Date: Aug. 22, 2019

(54) FIXING DEVICE AND IMAGE FORMING APPARATUS

(71) Applicant: Naoki IWAYA, Tokyo (JP)

(72) Inventor: Naoki IWAYA, Tokyo (JP)

(73) Assignee: Ricoh Company, Ltd., Tokyo (JP)

(21) Appl. No.: 16/229,722

(22) Filed: Dec. 21, 2018

(30) Foreign Application Priority Data
Feb. 16, 2018 (JP) 2018-025916

(51) Int. Cl. G03G 15/20

(52) U.S. Cl. CPC G03G 15/2039; G03G 2221/1645; G03G 15/2064; G03G 15/2053

(57) ABSTRACT

A fixing device includes a fixing rotator that is rotatable and a heater that heats the fixing rotator. An opposed rotator contacts the fixing rotator to form a fixing nip between the fixing rotator and the opposed rotator. A recording medium bearing an unfixed image is conveyed through the fixing nip. A temperature detector detects a temperature of the fixing rotator. A support supports the temperature detector. An air flow generator generates an air flow directed from a back face to a detecting face of the temperature detector.

### CROSS-REFERENCE TO RELATED APPLICATION

This patent application is based on and claims priority pursuant to 35 U.S.C. § 119(a) to Japanese Patent Application No. 2018-025916, filed on Feb. 16, 2018, in the Japan Patent Office, the entire disclosure of which is hereby incorporated by reference herein.

### BACKGROUND

### Technical Field

Exemplary aspects of the present disclosure relate to a fixing device and an image forming apparatus, and more particularly, to a fixing device for fixing an image on a recording medium and an image forming apparatus incorporating the fixing device.

Discussion of the Background Art Related-art image forming apparatuses, such as copiers, facsimile machines, printers, and multifunction peripherals (MFP) having two or more of copying, printing, scanning, facsimile, plotter, and other functions, typically form an image on a recording medium according to image data by electrophotography. Such image forming apparatuses include a fixing device that is requested to fix an unfixed toner image by controlling the temperature of a fixing rotator such as a fixing belt, a fixing film, and a fixing roller precisely. The fixing device may have a decreased thermal capacity to shorten a warmup time taken to heat the fixing rotator to a predetermined fixing temperature. Since the temperature of the fixing rotator fluctuates depending on an amount of heat received from a heater and drawn by the recording medium, a temperature detector that detects the temperature of the fixing rotator is requested to achieve precise response and detection.

A non-contact type infrared sensor (e.g., a thermopile) is used as a temperature detector. The thermopile is retained at a position spaced from a target object with a predetermined distance therebetween for temperature detection. If a detecting face of the thermopile is stained with a water droplet and a foreign substance such as a toner component, the thermopile may detect the temperature of the target object erroneously, causing faulty fixing.

### SUMMARY

This specification describes below an improved fixing device. In one embodiment, the fixing device includes a fixing rotator that is rotatable and a heater that heats the fixing rotator. An opposed rotator contacts the fixing rotator to form a fixing nip between the fixing rotator and the opposed rotator. A recording medium bearing an unfixed image is conveyed through the fixing nip. A temperature detector detects a temperature of the fixing rotator. A support supports the temperature detector. An air flow generator generates an air flow directed from a back face to a detecting face of the temperature detector.

This specification further describes an improved fixing device. In one embodiment, the fixing device includes a fixing rotator that is rotatable and a heater that heats the fixing rotator. An opposed rotator contacts the fixing rotator to form a fixing nip between the fixing rotator and the opposed rotator. A recording medium bearing an unfixed image is conveyed through the fixing nip. A temperature detector detects a temperature of the fixing rotator. A support supports the temperature detector. An air flow block is disposed in a gap between the support and the temperature detector. The air flow block blocks an air flow in a periphery of the temperature detector.

This specification further describes an improved image forming apparatus. In one embodiment, the image forming apparatus includes a fixing device including a fixing rotator that is rotatable and a heater that heats the fixing rotator. An opposed rotator contacts the fixing rotator to form a fixing nip between the fixing rotator and the opposed rotator. A recording medium bearing an unfixed image is conveyed through the fixing nip. A temperature detector detects a temperature of the fixing rotator. A support supports the temperature detector. An air flow generator generates an air flow directed from a back face to a detecting face of the temperature detector.

### BRIEF DESCRIPTION OF THE DRAWINGS

A more complete appreciation of the embodiments and many of the attendant advantages and features thereof can be readily obtained and understood from the following detailed description with reference to the accompanying drawings, wherein:

FIG. 1 is a schematic cross-sectional view of a printer according to an embodiment of the present disclosure;

FIG. 2 is a schematic cross-sectional view of a fixing device according to a first embodiment of the present disclosure, which is incorporated in the printer depicted in FIG. 1;

FIG. 3 is a schematic cross-sectional view of the fixing device depicted in FIG. 2 and peripheral elements thereof situated inside a body of the printer depicted in FIG. 1; and

FIG. 4 is a schematic cross-sectional view of a fixing device according to a second embodiment of the present disclosure, illustrating peripheral elements thereof situated inside the body of the printer depicted in FIG. 1.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

As used herein, the singular forms “a”, “an”, and “the” are intended to include the plural forms as well, unless the context clearly indicates otherwise.

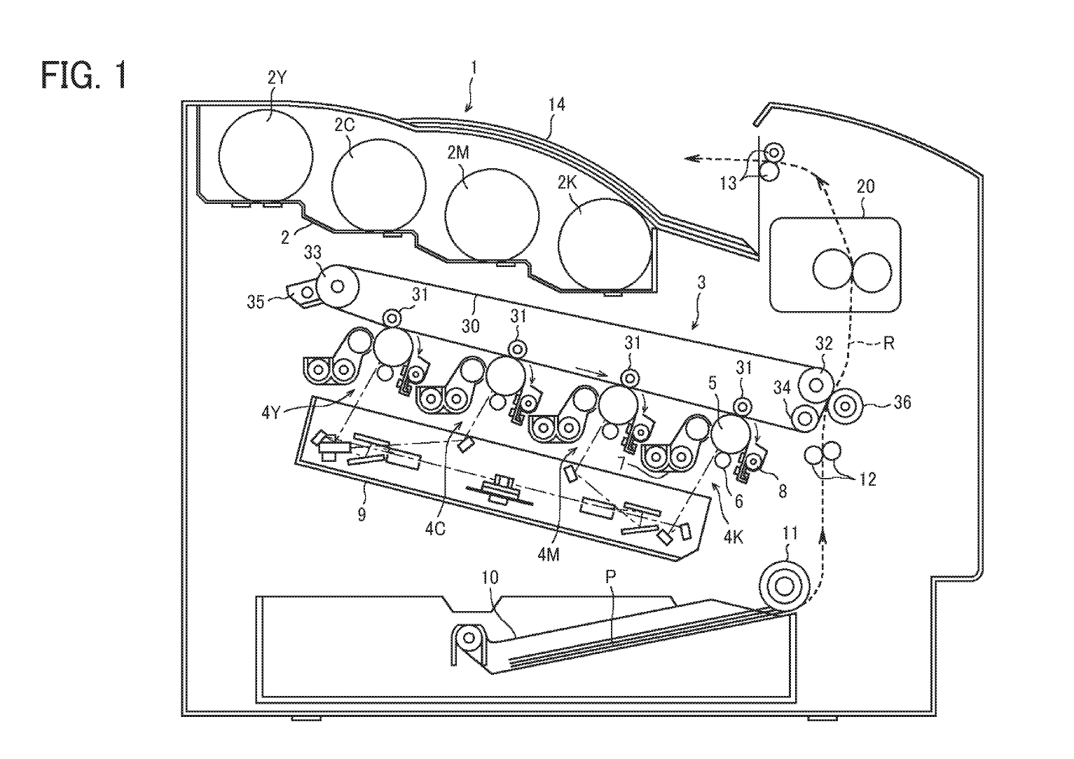

Referring now to the drawings, wherein like reference numerals designate identical or corresponding parts throughout the several views, particularly to FIG. 1, a printer 1 serving as an image forming apparatus is explained.

The image forming apparatus may be a copier, a facsimile machine, a printer, a multifunction peripheral or a multifunction printer (MFP) having at least two of copying, printing, scanning, facsimile, plotter, and other functions, or the like. According to this embodiment, the image forming apparatus is a color printer that forms color and monochrome toner images on a recording medium by electrophotography. Alternatively, the image forming apparatus may be a monochrome printer that forms a monochrome toner image on a recording medium.

FIG. 1 illustrates a general arrangement of the printer 1 serving as an image forming apparatus.

Referring to drawings, a description is provided of a construction of the printer 1, serving as an image forming apparatus that forms an image on a recording medium by electrophotography, according to an embodiment.

FIG. 1 is a schematic cross-sectional view of the printer 1 according to this embodiment. Four image forming devices 4Y, 4C, 4M, and 4K are disposed in a center of a body of the printer 1. The image forming devices 4Y, 4C, 4M, and 4K have a similar construction except that the image forming devices 4Y, 4C, 4M, and 4K contain developers in different colors, that is, yellow (Y), cyan (C), magenta (M), and black (K), respectively, which correspond to color separation components for a color image.

For example, each of the image forming devices 4Y, 4C, 4M, and 4K includes a photoconductor 5, a charger 6, a developing device 7, and a cleaner 8. The photoconductor 5 is drum-shaped and serves as a latent image bearer. The charger 6 charges a surface of the photoconductor 5. The developing device 7 supplies toner to the surface of the photoconductor 5. The cleaner 8 cleans the surface of the photoconductor 5. FIG. 1 assigns reference numerals to the photoconductor 5, the charger 6, the developing device 7, and the cleaner 8 of the image forming device 4K that forms a black toner image. Reference numerals for elements of the image forming devices 4Y, 4C, and 4M are omitted.

Below the image forming devices 4Y, 4C, 4M, and 4K is an exposure device 9 that exposes the surface of the photoconductor 5. The exposure device 9 includes a light source, a polygon mirror, an f-θ lens, and a reflecting mirror. The exposure device 9 irradiates the surface of each of the photoconductors 5 with a laser beam according to image data.

Above the image forming devices 4Y, 4C, 4M, and 4K is a transfer device 3. The transfer device 3 includes an intermediate transfer belt 30 serving as a transferor, four primary transfer rollers 31 serving as a primary transferor, a secondary transfer roller 36 serving as a secondary transferor, a secondary transfer backup roller 32, a cleaning backup roller 33, a tension roller 34, and a belt cleaner 35.

The intermediate transfer belt 30 is an endless belt stretched across the secondary transfer backup roller 32, the cleaning backup roller 33, and the tension roller 34. As the secondary transfer backup roller 32 is driven and rotated, the intermediate transfer belt 30 revolves around or rotates in a direction indicated by an arrow in FIG. 1.

The four primary transfer rollers 31 and the photoconductors 5 sandwich the intermediate transfer belt 30 to form primary transfer nips between the photoconductors 5 and the intermediate transfer belt 30, respectively. A power supply is connected to each of the primary transfer rollers 31 to apply at least one of a predetermined direct current (DC) voltage and a predetermined alternating current (AC) voltage to each of the primary transfer rollers 31.

The secondary transfer roller 36 and the secondary transfer backup roller 32 sandwich the intermediate transfer belt 30 to form a secondary transfer nip between the secondary transfer roller 36 and the intermediate transfer belt 30. Like the primary transfer rollers 31, the power supply is connected to the secondary transfer roller 36 to apply at least one of the predetermined direct current (DC) voltage and the predetermined alternating current (AC) voltage to the secondary transfer roller 36.

The belt cleaner 35 includes a cleaning brush and a cleaning blade that come into contact with the intermediate transfer belt 30. A waste toner conveyance tube extending from the belt cleaner 35 communicates with an inlet of a waste toner container.

A bottle housing 2 is disposed in an upper portion of the body of the printer 1. Four toner bottles 2Y, 2C, 2M, and 2K, which contain toners to be supplied to the image forming devices 4Y, 4C, 4M, and 4K, respectively, are detachably attached to the bottle housing 2. Supply tubes are disposed between the toner bottles 2Y, 2C, 2M, and 2K and the developing devices 7 so that toners are supplied from the toner bottles 2Y, 2C, 2M, and 2K to the developing devices 7 through the supply tubes, respectively.

In a lower portion of the body of the printer 1 are a sheet feeding tray 10 (e.g., a paper tray), a sheet feeding roller 11, and the like. The sheet feeding tray 10 stores sheets P serving as recording media. The sheet feeding roller 11 feeds and conveys a sheet P of the sheets P stored in the sheet feeding tray 10. The recording media include plain paper, thick paper, a postcard, an envelope, thin paper, coated paper, art paper, tracing paper, and an overhead projector (OHP) transparency. Optionally, the printer 1 may include a bypass sheet feeding tray.

A conveyance path R is disposed in the body of the printer 1. The sheet P is conveyed from the sheet feeding tray 10 through the conveyance path R via the secondary transfer nip to an outside of the printer 1. Upstream from the secondary transfer roller 36 in a sheet conveyance direction is a registration roller pair 12 serving as a conveyor that conveys the sheet P to the secondary transfer nip.

Downstream from the secondary transfer roller 36 in the sheet conveyance direction is a fixing device 20 that fixes an unfixed toner image transferred from the intermediate transfer belt 30 onto the sheet P thereon. Downstream from the fixing device 20 in the sheet conveyance direction in the conveyance path R is a sheet ejection roller pair 13 that ejects the sheet P onto the outside of the printer 1. A sheet ejection tray 14 (e.g., an output tray) is disposed atop the body of the printer 1. The sheet ejection tray 14 stocks the sheet P ejected onto the outside of the printer 1.

Referring to FIG. 1, a description is provided of basic operations of the printer 1 having the construction described above to perform image formation.

When image formation starts, that is, when the printer 1 receives a print job, a driver drives and rotates the photoconductor 5 of each of the image forming devices 4Y, 4C, 4M, and 4K clockwise in FIG. 1 so that the charger 6 charges the surface of the photoconductor 5 uniformly at a predetermined polarity. The exposure device 9 irradiates the charged surface of the photoconductor 5 with a laser beam, forming an electrostatic latent image on the surface of the photoconductor 5 in each of the image forming devices 4Y, 4C, 4M, and 4K. Image data used to expose the photoconductor 5 is monochrome image data created by decomposing desired full color image data into yellow, cyan, magenta, and black image data. The developing device 7 supplies toner to the electrostatic latent image formed on the photoconductor 5, visualizing the electrostatic latent image as a visible toner image.

Additionally, when image formation starts, the secondary transfer backup roller 32 is driven and rotated counterclockwise in FIG. 1, rotating the intermediate transfer belt 30 in the direction indicated by the arrow in FIG. 1. Each of the primary transfer rollers 31 is applied with a voltage at a polarity opposite a polarity of charged toner under one of a constant voltage control and a constant current control. Thus, a transfer electric field is created at the primary transfer nip formed between the photoconductor 5 and intermediate transfer belt 30 abutting on the primary transfer roller 31.

Thereafter, when the toner images formed on the photoconductors 5 reach the primary transfer nips in accordance with rotation of the photoconductors 5, the toner images formed on the photoconductors 5 are transferred onto the intermediate transfer belt 30 successively by the transfer electric fields created at the primary transfer nips such that the toner images are superimposed on the intermediate transfer belt 30, forming a full color toner image. Thus, the full color toner image is borne on a surface of the intermediate transfer belt 30. The cleaner 8 removes toner failed to be transferred onto the intermediate transfer belt 30 and therefore remained on the photoconductor 5 therefrom. Thereafter, a discharger discharges the surface of the photoconductor 5, initializing a surface potential of the photoconductor 5.

In the lower portion of the body of the printer 1, the sheet feeding roller 11 starts being driven and rotated, feeding a sheet P from the sheet feeding tray 10 to the conveyance path R. The registration roller pair 12 conveys the sheet P sent to the conveyance path R to the secondary transfer nip formed between the secondary transfer roller 36 and the intermediate transfer belt 30 pressed by the secondary transfer backup roller 32 at a time when the full color toner image formed on the intermediate transfer belt 30 reaches the secondary transfer nip. The secondary transfer roller 36 is applied with a transfer voltage having a polarity opposite the polarity of the charged toner of the full color toner image formed on the intermediate transfer belt 30, thus creating a transfer electric field at the secondary transfer nip.

Thereafter, when the full color toner image formed on the intermediate transfer belt 30 reaches the secondary transfer nip in accordance with rotation of the intermediate transfer belt 30, yellow, cyan, magenta, and black toner images that compose the full color toner image formed on the intermediate transfer belt 30 are transferred onto the sheet P collectively by the transfer electric field created at the secondary transfer nip. The belt cleaner 35 removes toner failed to be transferred onto the sheet P and therefore remained on the intermediate transfer belt 30 therefrom. The removed toner is conveyed and collected into the waste toner container.

Thereafter, the sheet P is conveyed to the fixing device 20 that fixes the unfixed full color toner image on the sheet P. The sheet P is ejected onto the outside of the printer 1 by the sheet ejection roller pair 13 and stocked on the sheet ejection tray 14.

The above describes image formation to form the full color toner image on the sheet P. Alternatively, one of the four image forming devices 4Y, 4C, 4M, and 4K may be used to form a monochrome toner image or two or three of the four image forming devices 4Y, 4C, 4M, and 4K may be used to form a bicolor toner image or a tricolor toner image.

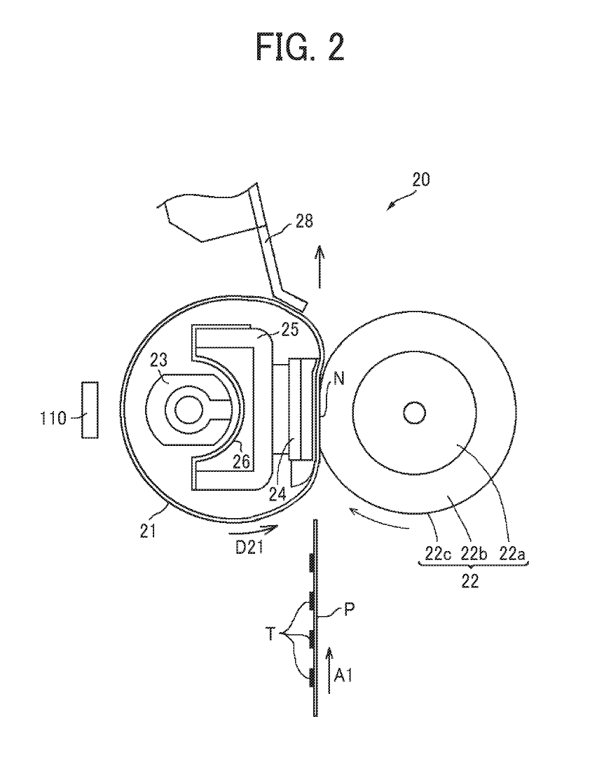

Referring to FIG. 2, a description is provided of a construction of the fixing device 20 incorporated in the printer 1 having the construction described above.

As illustrated in FIG. 2, the fixing device 20 includes a fixing belt 21, a pressure roller 22, a halogen heater 23, a nip forming pad 24, a stay 25, a reflector 26, and a separator 28. The fixing belt 21 serves as a fixing rotator or a fixing member that is rotatable. The pressure roller 22 serves as an opposed rotator that contacts the fixing belt 21 to form a fixing nip N between the fixing belt 21 and the pressure roller 22. The halogen heater 23 serves as a heater that heats the fixing belt 21. The nip forming pad 24 serves as a nip former disposed inside a loop formed by the fixing belt 21. The stay 25 serves as a support that supports the nip forming pad 24. The reflector 26 reflects light radiated from the halogen heater 23 to the fixing belt 21. The separator 28 separates the sheet P from the fixing belt 21. The fixing device 20 further includes a presser that presses the pressure roller 22 against the fixing belt 21. A thermopile 110 serves as a temperature detector that detects the temperature of the fixing belt 21. The thermopile 110 is disposed outside the fixing device 20 and inside the printer 1. Alternatively, the thermopile 110 may be disposed inside the fixing device 20.

A detailed description is now given of a construction of the fixing belt 21.

The fixing belt 21 is an endless belt or film that is thin and flexible. For example, the fixing belt 21 includes a base layer and a release layer. The base layer is an inner circumferential layer made of metal such as nickel and SUS stainless steel or resin such as polyimide (PI). The release layer is an outer circumferential layer made of tetrafluoroethylene-perfluoroalkylvinylether copolymer (PFA), polytetrafluoroethylene (PTFE), or the like. Optionally, an elastic layer made of rubber such as silicone rubber, silicone rubber foam, and fluororubber may be interposed between the base layer and the release layer.

A detailed description is now given of a construction of the pressure roller 22.

The pressure roller 22 includes a cored bar 22a, an elastic layer 22b, and a release layer 22c. The elastic layer 22b coats the cored bar 22a and is made of silicone rubber foam, silicone rubber, fluororubber, or the like. The release layer 22c coats the elastic layer 22b and is made of PFA, PTFE, or the like. The presser presses the pressure roller 22 toward the fixing belt 21, pressing the pressure roller 22 against the nip forming pad 24 via the fixing belt 21. At a position where the pressure roller 22 is pressed against the fixing belt 21, the elastic layer 22b of the pressure roller 22 is pressed and deformed to form the fixing nip N having a predetermined length in the sheet conveyance direction. A driver such as a motor disposed in the body of the printer 1 drives and rotates the pressure roller 22. As the driver drives and rotates the pressure roller 22, a driving force of the pressure roller 22 is transmitted to the fixing belt 21 at the fixing nip N, rotating the fixing belt 21 in accordance with rotation of the pressure roller 22.

According to this embodiment, the pressure roller 22 is a solid roller. Alternatively, the pressure roller 22 may be a hollow roller. In this case, a heater such as a halogen heater may be disposed inside the pressure roller 22. If the pressure roller 22 does not incorporate the elastic layer 22b, the pressure roller 22 attains a decreased thermal capacity that improves fixing property of being heated quickly. However, when the pressure roller 22 presses and deforms an unfixed toner image T to fix the toner image T on the sheet P, slight surface asperities of the fixing belt 21 may be transferred onto the toner image T, causing a solid part of the toner image T to suffer from variation in gloss. In order to prevent this, the pressure roller 22 preferably incorporates the elastic layer 22b having a thickness of 100 micrometers or more. The elastic layer 22b having the thickness of 100 micrometers or more, as the elastic layer 22b elastically deforms, absorbs the slight surface asperities of the fixing belt 21, preventing variation in gloss of the toner image T. The elastic layer 22b may be made of solid rubber. Alternatively, if no heater is disposed inside the pressure roller 22, the elastic layer 22b may be made of sponge rubber. The sponge rubber enhances thermal insulation of the pressure roller 22, preferably causing the pressure roller 22 to draw less heat from the fixing belt 21. Instead of a configuration in which an opposed rotator (e.g., the pressure roller 22) and a fixing rotator (e.g., the fixing belt 21) press against each other, the opposed rotator may merely contact the fixing rotator with no pressure therebetween.

A detailed description is now given of a configuration of the halogen heater 23.

Both ends of the halogen heater 23 in a longitudinal direction thereof are secured to side plates of the fixing device 20, respectively. The power supply disposed in the body of the printer 1 controls output to the halogen heater 23 to generate heat. The output to the halogen heater 23 is controlled according to a temperature of a surface of the fixing belt 21, which is detected by the thermopile 110. Such control of the output to the halogen heater 23 adjusts the temperature, that is, a fixing temperature, of the fixing belt 21 to a desired temperature. Alternatively, as a heater that heats the fixing belt 21, an induction heater (IH), a resistive heat generator, a carbon heater, or the like may be employed instead of a halogen heater.

A detailed description is now given of a configuration of the nip forming pad 24.

The nip forming pad 24 extends in a longitudinal direction thereof throughout an axial direction of the fixing belt 21 or the pressure roller 22. The nip forming pad 24 is secured to and supported by the stay 25. Hence, the nip forming pad 24 is not bent by pressure from the pressure roller 22, attaining a uniform nip length of the fixing nip N in the sheet conveyance direction throughout the axial direction of the pressure roller 22. In order to prevent the nip forming pad 24 from being bent, the stay 25 is preferably made of metal having an enhanced mechanical strength such as stainless steel and iron. Alternatively, the stay 25 may be made of resin.

The nip forming pad 24 is made of a heat resistant element having a heat resistant temperature of 200 degrees centigrade or higher. Accordingly, the nip forming pad 24 is immune from thermal deformation in a toner fixing temperature range, stabilizing the fixing nip N and quality of the toner image T output on the sheet P. The nip forming pad 24 is made of general heat resistant resin such as polyether sulfone (PES), polyphenylene sulfide (PPS), liquid crystal polymer (LCP), polyether nitrile (PEN), polyamide imide (PAI), and polyether ether ketone (PEEK).

The nip forming pad 24 is coated with a low friction sheet. While the fixing belt 21 rotates, the fixing belt 21 slides over the low friction sheet, decreasing a driving torque and a frictional load imposed on the fixing belt 21.

A detailed description is now given of a configuration of the reflector 26.

The reflector 26 is interposed between the stay 25 and the halogen heater 23. According to this embodiment, the reflector 26 is secured to the stay 25. Since the halogen heater 23 heats the reflector 26 directly, the reflector 26 is preferably made of metal or the like that has an increased melting point. The reflector 26 disposed as described above reflects light radiated from the halogen heater 23 to the stay 25 toward the fixing belt 21. Accordingly, the reflector 26 increases an amount of light that irradiates the fixing belt 21, heating the fixing belt 21 effectively. Additionally, the reflector 26 suppresses conduction of radiant heat from the halogen heater 23 to the stay 25 and the like, saving energy.

Alternatively, instead of the reflector 26 according to this embodiment, a heater side face of the stay 25, which is disposed opposite the halogen heater 23, may be treated with mirror finish by polishing, coating, or the like to produce a reflecting face. The reflector 26 or the refecting face of the stay 25 preferably has a reflectance of 90 percent or more.

In order to ensure the strength of the stay 25, the shape and the material of the stay 25 are not selected flexibly. Hence, the reflector 26 according to this embodiment that is separated from the stay 25 improves flexibility in selecting the shape and the material of the stay 25, specializing the reflector 26 and the stay 25 functionally. Since the reflector 26 is interposed between the halogen heater 23 and the stay 25, the reflector 26 is disposed in proximity to the halogen heater 23, heating the fixing belt 21 effectively.

In order to further improve efficiency in heating the fixing belt 21 by reflecting light, the direction of the reflector 26 or the reflecting face of the stay 25 is examined. For example, if the reflector 26 is disposed on a concentric circle with respect to the halogen heater 23 as a center, the reflector 26 may reflect light to the halogen heater 23, degrading heating efficiency. Conversely, if a part or an entirety of the reflector 26 is directed to reflect light to the fixing belt 21, not to the halogen heater 23, the reflector 26 decreases an amount of light reflected to the halogen heater 23, improving heating efficiency by reflection of light.

A description is provided of various structural advantages of the fixing device 20 according to this embodiment to save energy and improve a first print out time and the like further.

The first print out time is a time taken by the printer 1 to print and deliver a first page onto the sheet ejection tray 14 after receiving a print job.

For example, the halogen heater 23 heats the fixing belt 21 directly at a position other than the fixing nip N in a direct heating method. According to this embodiment, no element is interposed between the halogen heater 23 and a left span of the fixing belt 21, which is opposite the fixing nip N in FIG. 2. The halogen heater 23 heats the left span of the fixing belt 21 directly with radiant heat.

The fixing belt 21 is thin and has a decreased diameter to attain a decreased thermal capacity. For example, the base layer, the elastic layer, and the release layer of the fixing belt 21 have thicknesses in ranges of from 20 micrometers to 50 micrometers, from 100 micrometers to 300 micrometers, and from 10 micrometers to 50 micrometers, respectively. The fixing belt 21 has a total thickness of 1 mm or smaller. The fixing belt 21 has a diameter in a range of from 20 mm to 40 mm. In order to decrease the thermal capacity of the fixing belt 21 further, the fixing belt 21 has a total thickness of 0.2 mm or smaller preferably and 0.16 mm or smaller more preferably. The fixing belt 21 preferably has a diameter of 30 mm or smaller.

According to this embodiment, the pressure roller 22 has a diameter in a range of from 20 mm to 40 mm. Thus, the diameter of the fixing belt 21 is equivalent to the diameter of the pressure roller 22. However, the diameter of each of the fixing belt 21 and the pressure roller 22 is not limited to the above. For example, the diameter of the fixing belt 21 may be smaller than the diameter of the pressure roller 22. In this case, a curvature of the fixing belt 21 is greater than a curvature of the pressure roller 22 at the fixing nip N, facilitating separation of the sheet P ejected from the fixing nip N from the fixing belt 21.

A description is provided of a construction of a first comparative fixing device.

The first comparative fixing device includes a thermopile that is disposed at a position where water droplets do not accumulate on the thermopile or a cover that covers the thermopile to prevent a foreign substance from adhering to the thermopile, thus preventing erroneous detection of the thermopile.

However, when an air flow generates in a periphery of the thermopile and blows against a detecting face of the thermopile, even if the position of the thermopile is adjusted or the cover covers the thermopile, the water droplets and the foreign substance may adhere to the detecting face of the thermopile, causing faulty image formation.

A description is provided of a construction of a second comparative fixing device.

The second comparative fixing device includes a thermopile disposed opposite an outer surface of a heater (e.g., an electromagnetic induction heater) to prevent dew condensation on a detecting face of the thermopile. The thermopile is disposed below a fixing rotator so that the thermopile retracts from water vapor moving upward from a fixing nip. However, the second comparative fixing device does not address an air flow that generates in a periphery of the thermopile. Hence, if the air flow is directed to and blown against the detecting face of the thermopile, faulty fixing and faulty image formation may occur.

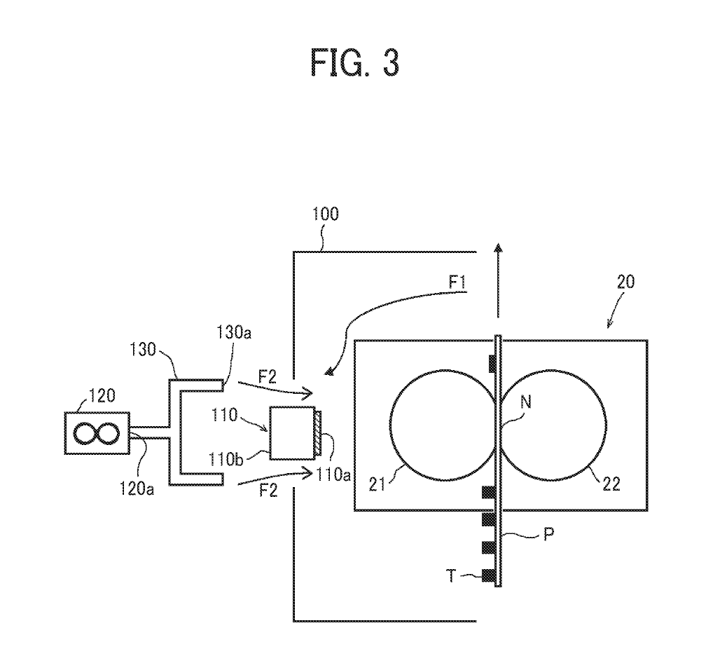

Referring to FIG. 3, a description is provided of a construction of the fixing device 20 according to a first embodiment.

FIG. 3 is a schematic cross-sectional view of the fixing device 20 and peripheral elements thereof situated inside the body of the printer 1. The fixing device 20 is disposed at a predetermined position with respect to a body structural member 100 (e.g., a frame). The fixing device 20 may be positioned with respect to the body structural member 100 directly or indirectly through a positioner provided separately from the body structural member 100. The body structural member 100 is a part of a frame disposed inside the body of the printer 1. The thermopile 110 is a non-contact type thermopile that detects the temperature of the fixing belt 21 disposed inside the fixing device 20. The body structural member 100 supports the thermopile 110 at an opposed position where the thermopile 110 is disposed opposite the fixing belt 21 to secure a predetermined distance between the thermopile 110 and the fixing belt 21. If the body structural member 100 supports the thermopile 110, a mounting hole or the like is provided, producing a gap between the body structural member 100 and the thermopile 110. If an air flow F1 directed from an exit of the fixing nip N to the thermopile 110 generates, an air channel directed to the thermopile 110 is produced, adhering moisture and wax to a detecting face 110a of the thermopile 110.

Alternatively, the fixing device 20 may support the thermopile 110. In this case, the predetermined distance is secured between the fixing belt 21 and the thermopile 110, upsizing the fixing device 20.

As illustrated in FIGS. 1 and 2, the sheet P is conveyed through the fixing device 20 upward in a direction A1. While the sheet P passes through the fixing nip N heated to a predetermined temperature to fix the unfixed toner image T on the sheet P, the sheet P discharges moisture contained in the sheet P. The sheet P also discharges a wax component and the like contained in toner.

If the moisture and the wax component discharged from the sheet P move upward together with the sheet P, no disadvantage occurs. However, for example, in accordance with rotation of the fixing belt 21, the air flow F1 may generate in a rotation direction D21 of the fixing belt 21 depicted in FIG. 2, that is, from the exit of the fixing nip N toward the thermopile 110. Accordingly, the moisture and the wax component that are discharged from the sheet P may move toward the gap between the body structural member 100 and the thermopile 110 and may adhere to the detecting face 110a of the thermopile 110, causing faulty detection of the thermopile 110.

To address this circumstance, a fan 120 serving as an air flow generator generates an air flow F2 that is directed from a back face 110b to the detecting face 110a of the thermopile 110 in a periphery of the thermopile 110 that is supported by the body structural member 100 of the printer 1 and used to detect the temperature of the fixing belt 21. For example, the fan 120 and a duct 130 are disposed in the printer 1. The back face 110b is opposite the detecting face 110a disposed opposite the fixing belt 21. The duct 130 serves as an air flow guide that communicates with an outlet 120a of the fan 120. A vent 130a of the duct 130 faces the back face 110b of the thermopile 110. The vent 130a of the duct 130 preferably faces the gap between the body structural member 100 and the thermopile 110. According to this embodiment, the vent 130a of the duct 130 is disposed rearward from the back face 110b of the thermopile 110, that is, at a distal position from the fixing belt 21. Alternatively, the vent 130a of the duct 130 may be disposed frontward from the back face 110b of the thermopile 110, that is, a proximal position to the fixing belt 21. For example, the vent 130a of the duct 130 may be disposed in proximity to the body structural member 100. The fan 120 may be disposed at an arbitrary position inside the printer 1. The length and the shape of the duct 130 extending from the fan 120 may be adjusted and the vent 130a of the duct 130 may face the back face 110b of the thermopile 110.

As described above, the air flow F2 that is directed from the back face 110b to the detecting face 110a of the thermopile 110 generates at the gap between the thermopile 110 and the body structural member 100. The air flow F2 drifts the moisture and the wax component that are discharged from the sheet P at the fixing nip N in a direction in which the moisture and the wax component move away from the thermopile 110, thus canceling the air flow F1 directed from the exit of the fixing nip N to the thermopile 110 and preventing the moisture and the wax component from adhering to the detecting face 110a of the thermopile 110.

The fan 120 may start at a time when the sheet P that discharges moisture and the like passes through the fixing nip N. Accordingly, the air flow F2 that is directed from the back face 110b to the detecting face 110a of the thermopile 110 generates at an appropriate time while saving power.

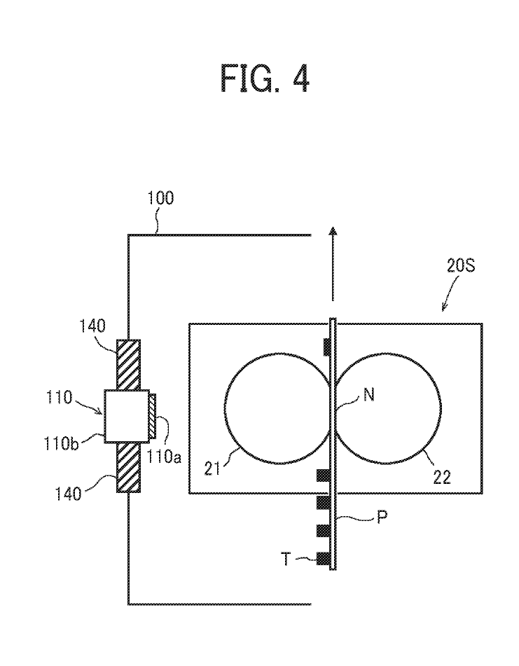

Referring to FIG. 4, a description is provided of a construction of a fixing device 20S according to a second embodiment.

According to this embodiment, a direction of an air flow is not controlled but the air flow that generates in the periphery of the thermopile 110 is blocked. As described above, if the body structural member 100 supports the thermopile 110, the mounting hole or the like is provided, producing the gap between the body structural member 100 and the thermopile 110. If the air flow directed from the exit of the fixing nip N to the thermopile 110 generates, the air channel directed to the thermopile 110 is produced, adhering moisture and wax to the detecting face 110a of the thermopile 110.

To address this circumstance, the fixing device 20S includes an elastic member 140 serving as an air flow block that blocks an air flow in the periphery of the thermopile 110 that is supported by the body structural member 100 of the printer 1 and used to detect the temperature of the fixing belt 21. The elastic member 140 is made of sponge, rubber, or the like, for example, and disposed at the gap between the body structural member 100 and the thermopile 110. Since the elastic member 140 fills the gap surrounding the thermopile 110 or in the periphery of the thermopile 110, the elastic member 140 blocks the air flow directed from the exit of the fixing nip N to the thermopile 110, preventing moisture and wax from adhering to the detecting face 110a of the thermopile 110. Since the elastic member 140 is made of sponge, rubber, or the like, the elastic member 140 does not adversely affect precision in installing and positioning the thermopile 110. Alternatively, instead of the elastic member 140, an adhesive such as adhesive tape may fill the gap surrounding the thermopile 110 or in the periphery of the thermopile 110 precisely. The adhesive is one example of the air flow block that blocks the air flow in the periphery of the thermopile 110 that is supported by the body structural member 100 of the printer 1 and used to detect the temperature of the fixing belt 21.

The elastic member 140 or the adhesive fills the gap surrounding the thermopile 110 or in the periphery of the thermopile 110 precisely to block the air flow precisely, thus eliminating the air flow directed to the detecting face 110a of the thermopile 110. However, water vapor is discharged upward. To address this circumstance, the thermopile 110 is preferably disposed below the exit of the fixing nip N.

As described above, the fixing devices 20 and 20S incorporated in an image forming apparatus that forms an image by electrophotography (e.g., the printer 1) include a non-contact type thermopile (e.g., the thermopile 110) serving as a temperature detector that detects the temperature of a fixing rotator (e.g., the fixing belt 21). An air flow generator (e.g., the fan 120) or an air flow block (e.g., the elastic member 140) prevents a water droplet and a foreign substance such as a toner component from adhering to and staining a detecting face of the thermopile, preventing the thermopile from detecting the temperature of the fixing rotator erroneously. The air flow surrounding the thermopile or in the periphery of the thermopile is controlled with the air flow generator that generates the air flow directed from a back face to the detecting face of the thermopile or the air flow block that blocks the air flow surrounding the thermopile or in the periphery of the thermopile, preventing the water droplet and the foreign substance from adhering to the detecting face of the thermopile. Accordingly, the air flow generator and the air flow block prevent faulty detection of the thermopile and thereby prevent faulty image formation.

A description is provided of advantages of a fixing device (e.g., the fixing devices 20 and 20S).

As illustrated in FIGS. 2, 3, and 4, the fixing device includes a fixing rotator (e.g., the fixing belt 21), an opposed rotator (e.g., the pressure roller 22), a heater (e.g., the halogen heater 23), a temperature detector (e.g., the thermopile 110), a support (e.g., the body structural member 100), and an air flow generator (e.g., the fan 120). The fixing rotator is rotatable in a predetermined direction of rotation. The opposed rotator contacts the fixing rotator to form a fixing nip (e.g., the fixing nip N) therebetween. The heater heats the fixing rotator. As a recording medium bearing an unfixed image is conveyed through the fixing nip, the fixing rotator and the opposed rotator fix the unfixed image on the recording medium. The temperature detector is supported by the support disposed in the fixing device or an image forming apparatus (e.g., the printer 1) incorporating the fixing device. The temperature detector detects a temperature of the fixing rotator. The air flow generator generates an air flow (e.g., the air flow F2) directed from a back face (e.g., the back face 110b) to a detecting face (e.g., the detecting face 110a) of the temperature detector.

Accordingly, the air flow in a periphery of the temperature detector is controlled. For example, the air flow generator that generates the air flow directed from the back face to the detecting face of the temperature detector prevents a water droplet and a foreign substance from adhering to the detecting face of the temperature detector. Consequently, the air flow generator prevents faulty detection of the temperature detector and thereby prevents faulty image formation.

According to the embodiments described above, the fixing belt 21 serves as a fixing rotator. Alternatively, a fixing film, a fixing sleeve, a fixing roller, or the like may be used as a fixing rotator. Further, the pressure roller 22 serves as an opposed rotator. Alternatively, a pressure belt or the like may be used as an opposed rotator.

The above-described embodiments are illustrative and do not limit the present disclosure. Thus, numerous additional modifications and variations are possible in light of the above teachings. For example, elements and features of different illustrative embodiments may be combined with each other and substituted for each other within the scope of the present disclosure.

Any one of the above-described operations may be performed in various other ways, for example, in an order different from the one described above.

What is claimed is:

1. A fixing device comprising:
a fixing rotator that is rotatable;
a heater to heat the fixing rotator;
an opposed rotator to contact the fixing rotator to form a fixing nip between the fixing rotator and the opposed rotator, the fixing nip through which a recording medium bearing an unfixed image is conveyed;
a temperature detector to detect a temperature of the fixing rotator;
a support supporting the temperature detector; and
an air flow generator to generate an air flow directed from a back face to a detecting face of the temperature detector.

2. The fixing device according to claim 1,
wherein the detecting face of the temperature detector is disposed opposite the fixing rotator and the back face of the temperature detector is opposite the detecting face.

3. The fixing device according to claim 1, further comprising an air flow guide including a vent facing the back face of the temperature detector,
wherein the air flow generator includes an outlet communicating with the air flow guide.

4. The fixing device according to claim 3,
wherein the air flow guide further includes a duct.

5. The fixing device according to claim 1,
wherein the air flow generator includes a fan.

6. The fixing device according to claim 1,
wherein the temperature detector includes a thermopile.

7. A fixing device comprising:
a fixing rotator that is rotatable;
a heater to heat the fixing rotator;
an opposed rotator to contact the fixing rotator to form a fixing nip between the fixing rotator and the opposed rotator, the fixing nip through which a recording medium bearing an unfixed image is conveyed;
a temperature detector to detect a temperature of the fixing rotator;
a support supporting the temperature detector; and
an air flow block disposed in a gap between the support and the temperature detector, the air flow block to block an air flow in a periphery of the temperature detector.

8. The fixing device according to claim 7,
wherein the temperature detector is disposed below an exit of the fixing nip.

9. The fixing device according to claim 7,
wherein the air flow block includes an elastic member made of one of sponge and rubber.

10. An image forming apparatus comprising:
a fixing device including:
a fixing rotator that is rotatable;
a heater to heat the fixing rotator;
an opposed rotator to contact the fixing rotator to form a fixing nip between the fixing rotator and the opposed rotator, the fixing nip through which a recording medium bearing an unfixed image is conveyed; and
a temperature detector to detect a temperature of the fixing rotator;
a support supporting the temperature detector; and
an air flow generator to generate an air flow directed from a back face to a detecting face of the temperature detector.

11. The image forming apparatus according to claim 10, further comprising an air flow guide including a vent facing the back face of the temperature detector, the air flow guide being disposed outside the fixing device,
wherein the air flow generator includes an outlet communicating with the air flow guide.

12. The image forming apparatus according to claim 10,
wherein the support includes a frame.
